(19) United States
(12) Patent Application Publication
(10) Pub. No.: US 2016/0236335 A1
(43) Pub. Date: Aug. 18, 2016

(54) TORQUE SCREWDRIVER

(71) Applicant: KABO TOOL COMPANY, Taichung City (TW)

(72) Inventor: Chih-Ching HSIEH, Taichung City (TW)

(21) Appl. No.: 14/856,570

(22) Filed: Sep. 17, 2015

Related U.S. Application Data
(60) Provisional application No. 62/116,570, filed on Feb. 16, 2015.

(51) Int. Cl. B25B 23/14; B25B 23/142; B25B 15/04

(52) U.S. Cl. CPC B25B 23/141; B25B 15/04; B25B 23/1427

(57) ABSTRACT

A torque screwdriver includes a handle, a tube body, a torque adjusting mechanism, a tripping mechanism, a driving base and a driving head. The tube body is connected to the handle. The torque adjusting mechanism is disposed in the tube body and for providing a predetermined torque value. The tripping mechanism is disposed in the tube body, and one end of the tripping mechanism is pushed by the torque adjusting mechanism. The driving base is disposed in the tube body and located in the tube body, and one end of the driving base is pushed by the other end of the tripping mechanism. The driving head is connected to the tube body, the driving head is embedded between the driving base and an inner wall of the tube body, wherein a gap is formed between the driving head and the tube body.

### RELATED APPLICATIONS

This application claims priority to U.S. Provisional Patent Application No. 62/116,570, filed Feb. 16, 2015, which is herein incorporated by reference.

### BACKGROUND

1. Technical Field

The present disclosure relates to a torque screwdriver.

2. Description of Related Art

Screwdriver is a wide used hand tool in the conventional industry or daily lives, wherein torque screwdriver is a common type of the various types of the screwdriver, which can be used to tighten the external elements, such as screws, screw bolts or screw nuts, etc.

In general, the torque screwdriver includes a handle, a tube body and a driving head, wherein the driving head is for directly connecting and driving the external element by providing torque thereto. However, during using the torque screwdriver, the friction between the tube body and the driving head would be generated easily, it would easily occur the abrasion between the tube body and the driving head.

Further, the driving head is embedded to the tube body, generally. Hence, when the external element has long arm, the driving head would be stuck easily, and excessive noise would be generated.

### SUMMARY

According to one aspect of the present disclosure, a torque screwdriver includes a handle, a tube body, a torque adjusting mechanism, a tripping mechanism, a driving base and a driving head. One end of the tube body is connected to the handle. The torque adjusting mechanism is disposed in the tube body and for providing a predetermined torque value. The tripping mechanism is disposed in the tube body, and one end of the tripping mechanism is pushed by the torque adjusting mechanism. The driving base is disposed in the tube body and located in the other end of the tube body, and one end of the driving base is pushed by the other end of the tripping mechanism. The driving head is connected to the other end of the tube body, one end of the driving head is embedded between the driving base and an inner wall of the tube body, and the driving head is driven by the driving base, wherein the driving head includes an embedding structure and a stepped structure. The embedding structure is located on an outer wall of the end of the driving head, and against to the inner wall of the tube body. The stepped structure is located on the outer wall of the end of the driving head for forming a gap between the inner wall of the tube body and thereof.

According to another aspect of the present disclosure, a torque screwdriver includes a handle, a tube body, a torque adjusting mechanism, a tripping mechanism, a driving base, a driving head and a self-calibrated mechanism. One end of the tube body is connected to the handle. The torque adjusting mechanism is disposed in the tube body and for providing a predetermined torque value. The tripping mechanism is disposed in the tube body, and one end of the tripping mechanism is pushed by the torque adjusting mechanism. The driving base is disposed in the tube body and located in the other end of the tube body, and one end of the driving base pushed by the other end of the tripping mechanism. The driving head is connected to the other end of the tube body, one end of the driving head is embedded between the driving base and an inner wall of the tube body, and the driving head is driven by the driving base, wherein a gap is formed between the driving head and the tube body. The self-calibrated mechanism is located between the driving head and the driving base for aligning an axis of the driving base with an axis of the driving head.

According to yet another aspect of the present disclosure, a torque screwdriver includes a handle, a tube body, a torque adjusting mechanism, a tripping mechanism, a driving base and a driving head. The tube body includes an upper tube body connected to the handle and a lower tube body connected to the upper tube body, wherein a diameter of the lower tube body is greater than a diameter of the upper tube body. The torque adjusting mechanism is disposed in the upper tube body and for providing a predetermined torque value. The tripping mechanism disposed in the lower tube body, and includes a first ball member and at least two second ball members, wherein the first ball member is against to the torque adjusting mechanism, and the second ball members are slidably pushed by the first ball member, and against to an inner wall of the lower tube body. The driving base is disposed in the lower tube body, the first ball member and the second ball members are contained in one end of the driving base. The driving head is connected to the other end of the tube body, one end of the driving head is embedded between the driving base and the inner wall of the lower tube body, and the driving head is driven by the driving base, wherein a gap is formed between the driving head and the tube body.

### BRIEF DESCRIPTION OF THE DRAWINGS

FIG. 1 is a schematic view of an appearance of a torque screwdriver according to one embodiment of the present disclosure;

FIG. 2 is a cross-sectional view of the torque screwdriver according to the embodiment of FIG. 1;

FIG. 3 is a partial enlarged view of the torque screwdriver according to the embodiment of FIG. 2;

FIG. 4 is an exploded view of the torque screwdriver according to the embodiment of FIG. 1;

FIG. 5A is a cross-sectional view taken along line 5-5 of one state of the torque screwdriver of FIG. 2;

FIG. 5B is a cross-sectional view taken along line 5-5 of another state of the torque screwdriver of FIG. 2;

FIG. 6 is a cross-sectional view of a torque screwdriver according to another embodiment of the present disclosure;

FIG. 7 is a cross-sectional view of a torque screwdriver according to further another embodiment of the present disclosure; and

FIG. 8 is a cross-sectional view of the driving head of the torque screwdriver according to the embodiment of FIG. 7.

### DETAILED DESCRIPTION

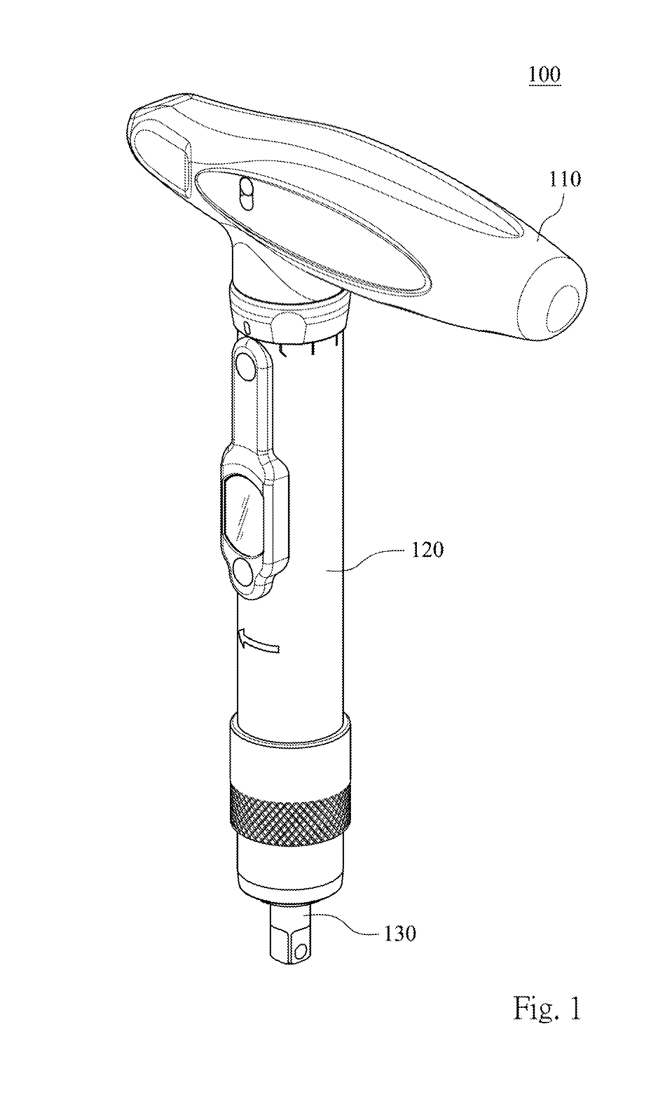

FIG. 1 is a schematic view of an appearance of a torque screwdriver 100 according to one embodiment of the present disclosure. In FIG. 1, the torque screwdriver 100 includes a handle 110, a tube body 120 and a driving head 130. The handle 110 and the driving head 130 are connected to two end of the tube body 120, respectively. The user can hold the handle 110 for driving the tube body 120 and linking the driving head 130 to rotate, so that the external element (not shown) can be screwed to the predetermined position.

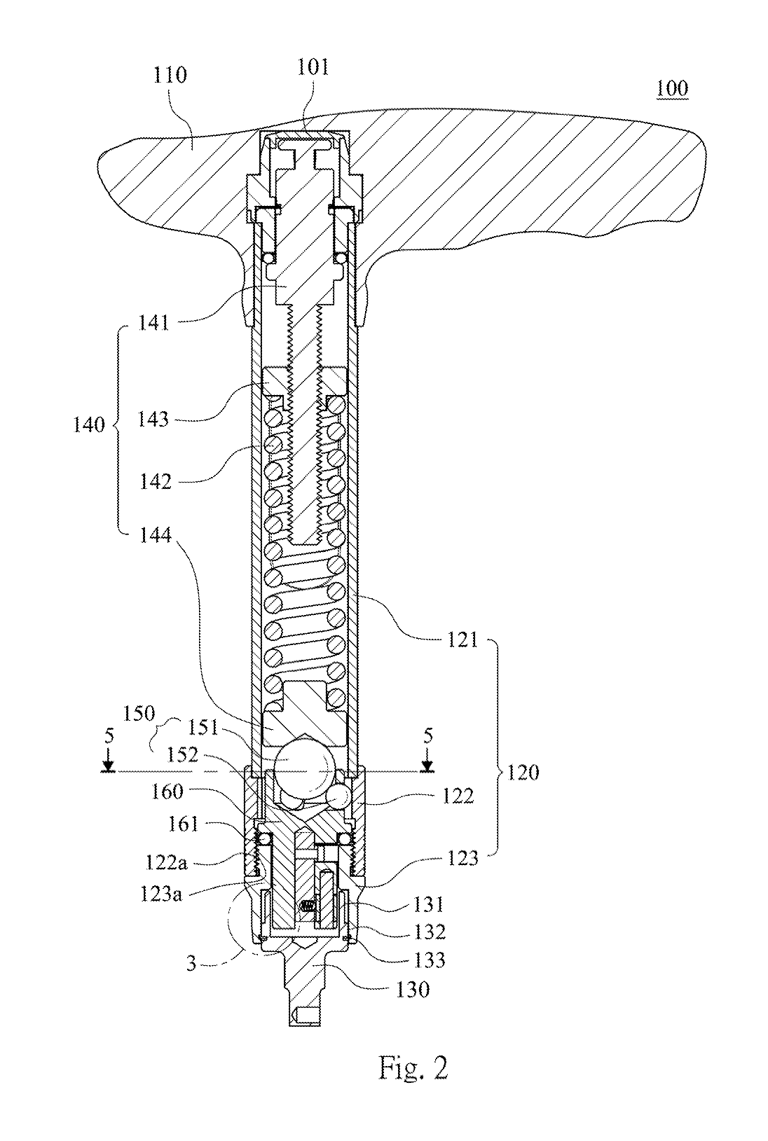

FIG. 2 is a cross-sectional view of the torque screwdriver 100 according to the embodiment of FIG. 1. The torque screwdriver 100 further includes a torque adjusting mechanism 140, a tripping mechanism 150 and a driving base 160. The torque adjusting mechanism 140 is disposed in the tube body 120 and for providing a predetermined torque value. The tripping mechanism 150 is disposed in the tube body 120, and one end of the tripping mechanism 150 is pushed by the torque adjusting mechanism 140. The driving base is disposed in the tube body 120 and located in the other end which connected to the driving head 130 of the tube body 120, and one end of the driving base 160 is pushed by the other end of the tripping mechanism 150. According to the embodiment of FIG. 2, the driving base 160 is an unidirectional ratchet for driving the driving head 130 to rotate in a predetermined direction.

In detail, the driving head 130 is connected to the other end of the tube body 120, and the end of the driving head 130 which connected to the tube body 120 is embedded between the driving base 160 and an inner wall of the tube body 120, and the driving head 130 is driven by the driving base 160. The driving head 130 includes a stepped structure 131 and an embedding structure 132, wherein the stepped structure 131 is located on the outer wall of the end of the driving head 130 which is connected to the tube body 120, and is for forming a gap between the inner wall of the tube body 120 and thereof, and the embedding structure is located on an outer wall of the end of the driving head 130 which is connected to the tube body 120, and against to the inner wall of the tube body 120. According to the embodiment of FIG. 2 the stepped structure 131 is a groove.

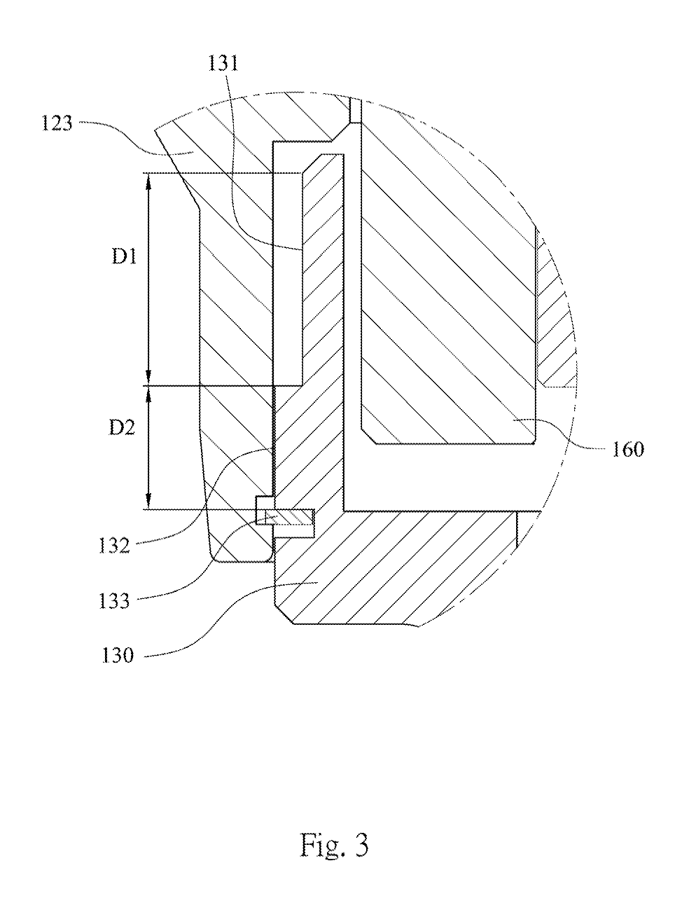

FIG. 3 is a partial enlarged view of the torque screwdriver 100 according to the embodiment of FIG. 2. In the embodiment of FIG. 3, an axial length of the stepped structure 131 is D1, an axial length of the embedding structure 132 is D2, wherein D1 is greater than D2. The conventional torque screwdriver has the driving head without the stepped structure arranged thereon, and it would generate excessive frictional force to lead the fluent driven of the driving head, and to generate loud noise during working. Further, when the axial length of the embedded portion between the driving head and the tube body is too long, the stress between the driving head and the tube body under the lever principle would be excessive during using the torque screwdriver, so that the driving head would be stuck easily due to the deformation thereof. Hence, the stepped structure 131 according to the embodiment not only can reduce the frictional force, but also can reduce the frictional area and the arm forced on the external element by the arrangement of the axial length D1 which is greater than the axial length D2 and the embedded area between the driving head 130 and the tube body 120 which is smaller than the gap. Thus, the driving head would not be stuck, and the noise can be reduced.

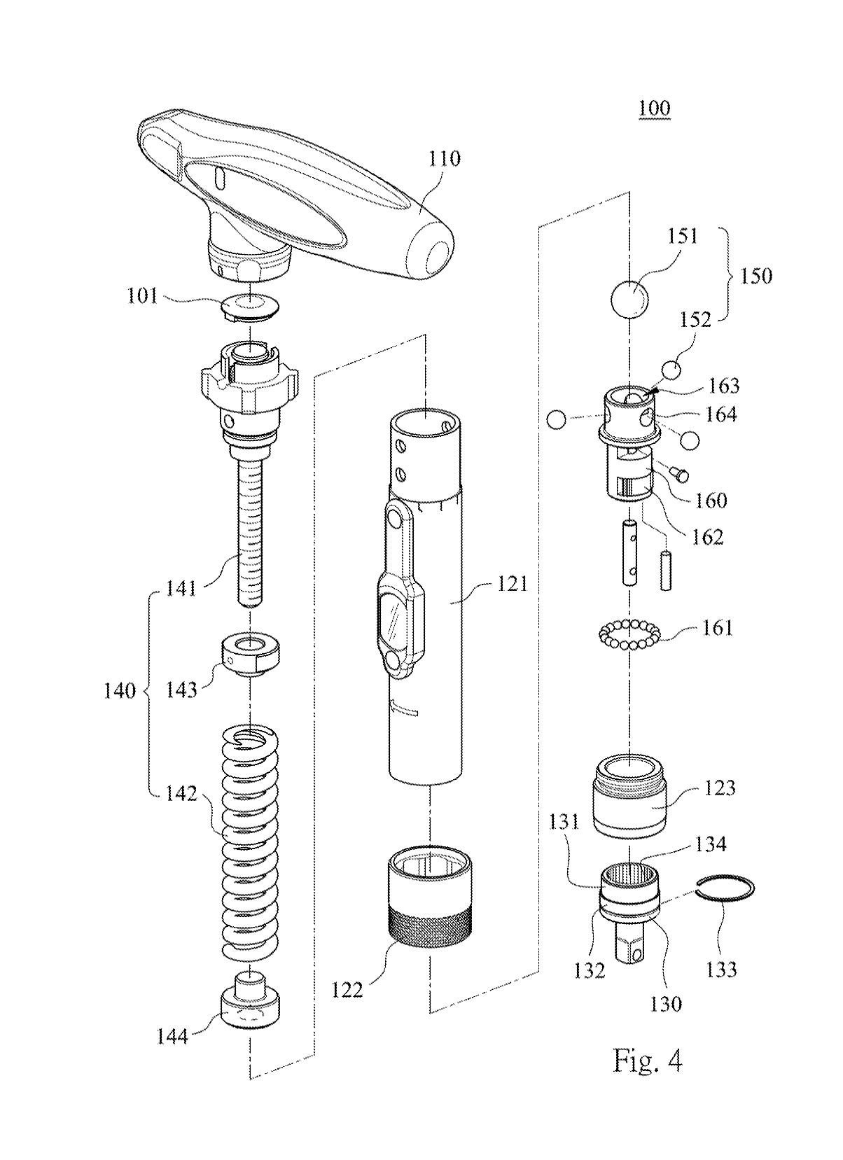

FIG. 4 is an exploded view of the torque screwdriver 100 according to the embodiment of FIG. 1. In the embodiment of FIG. 4, the tube body 120 can include an upper tube body 121, a lower tube body 122 and a sleeving member 123. The upper tube body 121 is connected to the handle 110, and the torque adjusting mechanism 140 is disposed therein. The lower tube body 122 is connected to the upper tube body 121, and the tripping mechanism 15 is disposed therein, wherein the lower tube body is welded to the upper tube body in the embodiment of FIG. 4. The sleeving member 123 connects the lower tube body 122 and the driving head 130. The lower tube body 122 includes a first connecting structure 122a located on the inner wall thereof, and the sleeving member 123 includes a second connecting structure 123a located on the outer wall thereof, wherein the lower tube body 122 is connected to the sleeving member 123 by the connection of the first connecting structure 122a and the second connecting structure 123a. The driving base 160 can be rotated corresponding to the sleeving member 123. One end of the driving head 130 is tube-shaped, and the end of the driving head 130 can be embedded between the driving base 160 and the tube body 120. A pivoting ring 133 is disposed between the driving head 130 and the sleeving member 123. The protruding embedding structure 132 of the driving head 130 is against to the inner wall of the sleeving member 123, and the gap is formed between the depressed stepped structure 131 and the sleeving member 123 of the tube body 120. The driving base 160 is an unidirectional ratchet, wherein a tooth element 162 of the unidirectional ratchet element is unidirectionally meshed to a tooth portion 132 on the inner wall of the driving head 130, so that the driving head 130 can be linked. 100231 Furthermore, the torque screwdriver 100 can further include a bearing 161 disposed between the sleeving member 123 and the driving head 160. Therefore, the rotation between the driving head 160 and the sleeving member 123 can be stably and fluent, so that the friction between the elements of the torque screwdriver 100 can be avoided, and the useful life of the torque screwdriver 100 can be extended.

According to the embodiment of FIGS. 2 and 4, the torque adjusting mechanism 140 includes an adjusting lever 141, an elastic member 142, a sliding member 143 and a pushing member 144. On end of the adjusting lever 141 is connected to the handle 110, so that the handle 110 can drive the torque adjusting mechanism 140. The elastic member 142 can be surrounded the adjusting lever 141, one end of the elastic member 142 is connected against to the sliding member 143, and the sliding member 143 can axially move along the adjusting lever 141. The compression of the elastic member 142 can be adjusted by the axial movement of the sliding member 143 for changing the predetermined torque value of the torque adjusting mechanism 140. The pushing member 144 is connected against to the other end of the elastic member 142, and is connected against to the tripping mechanism 150.

In FIG. 4, the tripping mechanism 150 includes a first ball member 151 and at least two second ball members 152, wherein the first ball member 151 and the second ball members 152 are contained in the end of the driving base 160. The first ball member 151 is against to the torque adjusting mechanism 140, that is, the first ball member 151 is pushed by the elastic member 142 via the pushing member 144. The second ball members 152 are slidably pushed by the first ball member 151, and against to the inner wall of the lower tube body 122. According to the embodiment of FIG. 4, the tripping mechanism 150 includes three second ball members 152.

Further, the driving base 160 can further include a containing groove 163 and at least two through holes 164. In detail, the first ball member 151 and the second ball members 152 are located in the containing groove 163. The through holes 164 are formed on the side wall of the containing groove 163, wherein the second ball members 152 are against to the inner wall of the lower tube body 122 through the through holes 164. According to the embodiment of FIG. 4, the driving base 160 includes three through holes 164.

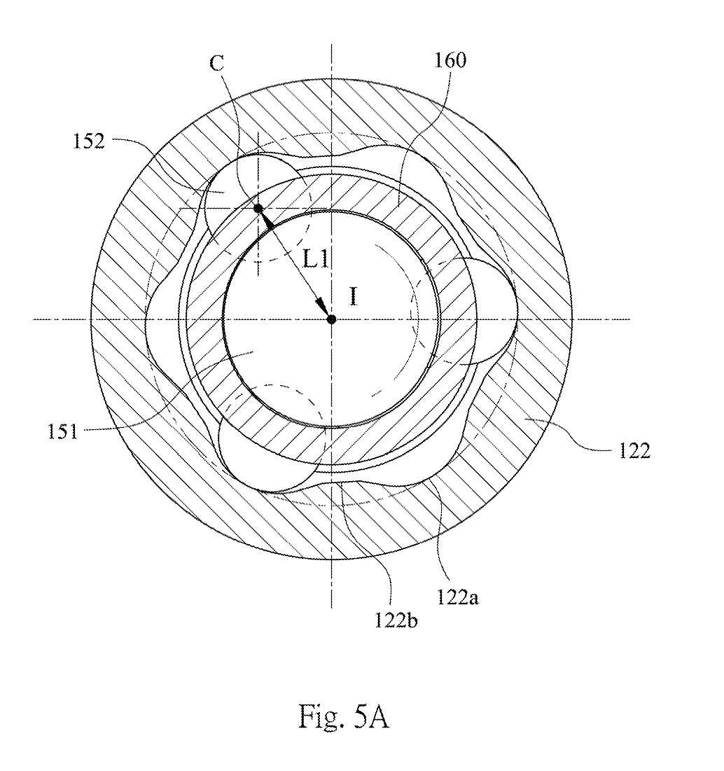

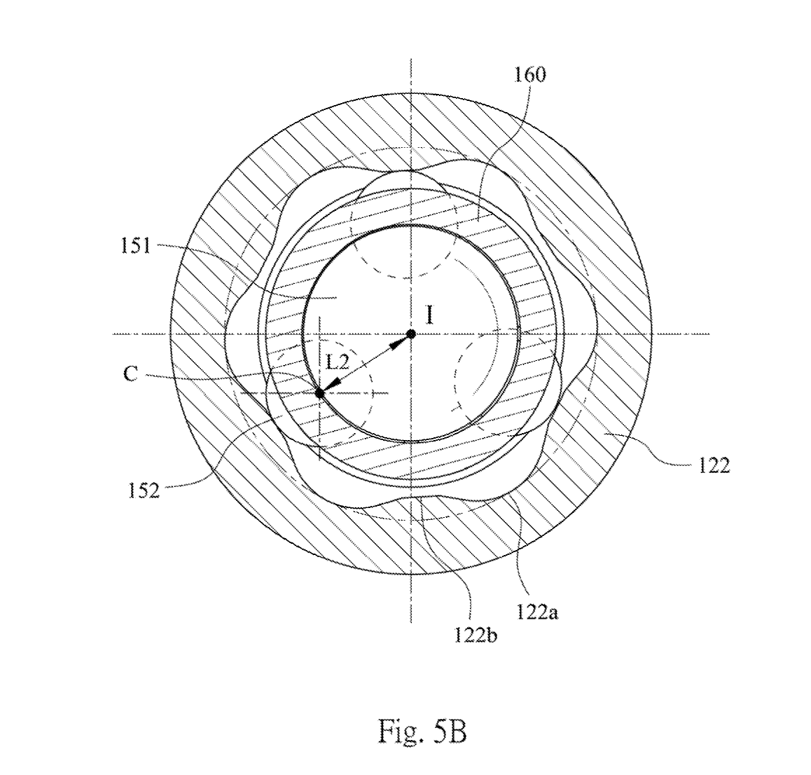

FIGS. 5A and 5B are cross-sectional views taken along line 5-5 of two states of the torque screwdriver 100 of FIG. 2. In FIG. 5A, when each of the second ball members 152 is driven in a driving position, a radial distance perpendicular to an axial line I of the lower tube body 122 of the tube body 120 between the axial line I of the lower tube body 122 and the a center C each of the second ball members 152 is L1. In FIG. 5B, when each of the second ball members is driven in a tripping position, a radial distance perpendicular to the axial line of the tube body between the axial line of the tube body and the a center of each of the second ball members is L2, and L1 is greater than L2. Therefore, when the torque screwdriver 100 provides the torque to the external element, and the torque value is greater than the predetermined torque value, the second ball members 152 will be pushed from the driving position to the tripping position.

In detail, the lower tube body 122 can include at least four positioning areas 122a and at least four tripping areas 122b located on the inner wall thereof, wherein, according to the embodiment of FIGS. 5A and 5B, the lower tube body 122 includes six positioning areas 122a and six tripping areas 122b located on the inner wall thereof. The positioning areas 122a are axial grooves of the lower tube body 122, and the positioning areas 122a and the tripping areas 122b are alternately located on the inner wall of the lower tube body 122, and each of the positioning areas 122a is connected to each of the tripping areas 122b which is adjacent thereto. As shown in FIG. 5A, when the second ball members 152 is located on the driving position, the second ball members 152 are against to the positioning areas 122a through the through holes 164.

When the torque screwdriver 100 is driven, the driving base 160 can be rotated via the tube body 120, and the driving head 130 can be linked for providing torque to the external element, at the same time, the torque adjusting mechanism 140 provides pressure to the first ball member 151. The second ball members 152 are pushed by the pressure providing from the torque adjusting mechanism 140 indirectly via the first ball member 151, so that the second ball members 152 can be positioned in the containing groove 163 and against to the positioning areas 122a through the through holes 164.

When the torque value provided to the external element is greater than the predetermined torque value, the feedback torque value from the driving head 130 is greater than the pressure pushed on the second bail members 152, and the second ball members 152 would be pushed from the positioning areas 122a to the tripping areas 122b. At the same time, the driving base 160 and the driving head 130 cannot be linked with the tube body 120. Therefore, the excessive torque provided to the external element can be avoided. Moreover, the number of the second ball members 152 can be two, three or more, the number of the positioning areas 122a and the number of the tripping areas 122b can be changed for adapting to the number of the second ball members 152, and the tripping areas 122b can also be arranged as axial protruding-shaped, and will not be limited to the foregoing description.

The tripping mechanism 150 is disposed in the upper tube body 121, and the second ball members 152 are against to the inner wall of the upper tube body, so that a diameter of the lower tube body 122 can be greater than a diameter of the upper tube body 121. Further, the upper tube body 121 is for containing the torque adjusting mechanism 140, so that an axial length of the upper tube body 121 can be greater than an axial length of the lower tube body 122. Therefore, the weight and volume of the torque screwdriver 100 can be reduced, and the manufacturing cost can also be reduced.

The torque screwdriver 100 can further include a gasket 101 disposed between the handle 110 and the tube body 120. Precisely. the gasket 101 is disposed between the adjusting lever 141 located in the tube body 120 and the handle 110. Therefore, it is favorable for the position and the connection between the handle 110 and the adjusting lever 141.

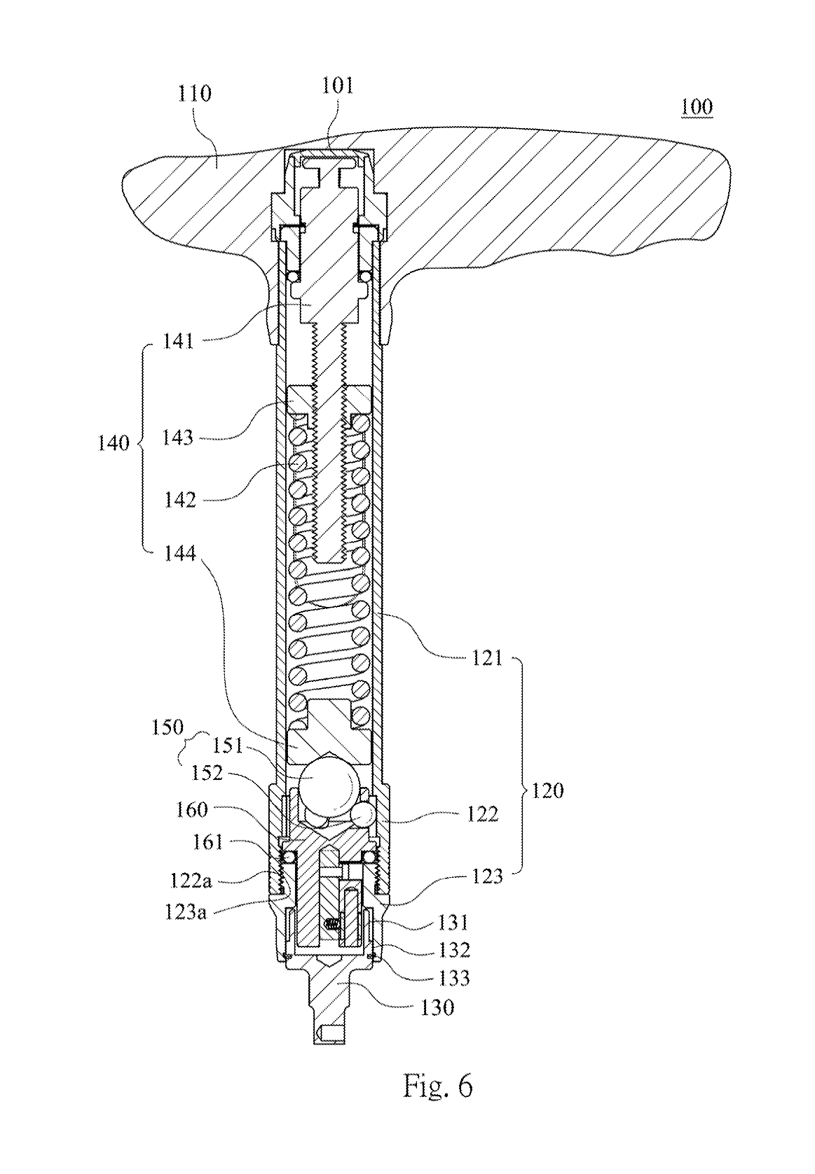

FIG. 6 is a cross-sectional view of a torque screwdriver 100 according to another embodiment of the present disclosure. In FIG. 6, the lower tube body 122 is integrated with the upper tube body 121. Therefore, the assembling and manufacturing of the torque screwdriver 100 can be simplified, and the manufacturing cost can also be reduced.

According to the embodiment of FIG. 6, the elements and the arrangements thereof in the torque screwdriver 100 are the same as the foregoing description, and will not be described again herein.

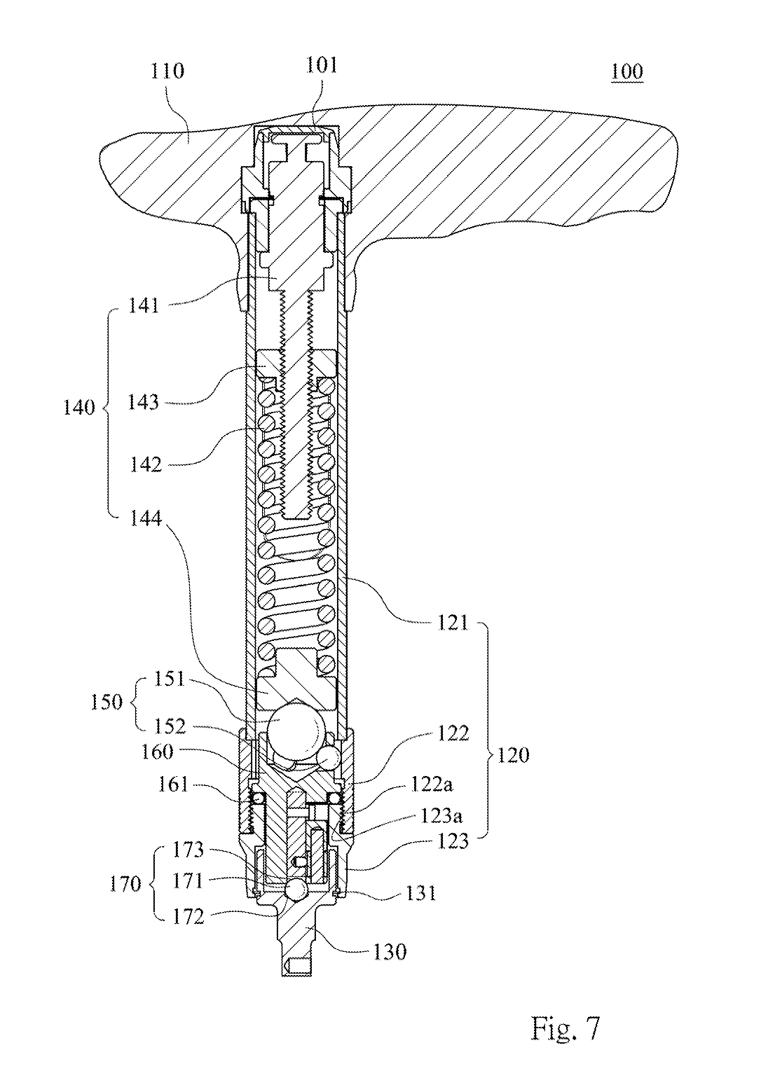

FIG. 7 is a cross-sectional view of a torque screwdriver 100 according to further another embodiment of the present disclosure. In FIG. 7, the torque screwdriver 100 includes a handle 110, a tube body 120, a torque adjusting mechanism 140, a tripping mechanism 150, a driving base 160, a driving head 130 and a self-calibrated mechanism 170, wherein the arrangements of the handle 110, the tube body 120, the torque adjusting mechanism 140, the tripping mechanism 150, the driving base 160 and the driving head 130 are the same as the foregoing description, and will not be described again herein.

Especially, the self-calibrated mechanism 170 is located between the driving head 130 and the driving base 160 for aligning an axis of the driving base 160 with an axis of the driving head 130. Hence, the tilt of the driving base 160 during using can be avoided so as to ensure the mesh between the tooth element 162 of the driving base 160 and the tooth portion 132 on the inner wall of the driving head 130.

In detail, the self-calibrated mechanism 170 includes a ball 171 against to the driving head 130 and the driving base 160, so that the axis of the driving base 160 can be aligned with the axis of the driving head 130 via the bail 171. Therefore, the tilt of the driving base 160 during using can be avoided so as to ensure the mesh between the tooth element 162 of the driving base 160 and the tooth portion 132 on the inner wall of the driving head 130.

Furthermore, the self-calibrated mechanism 170 can further include a first groove 172 and a second groove 173, wherein the first groove 172 is formed on one end of the driving head 130 for containing the ball 171 therein, and the second groove 173 is formed on one end of the driving base 160 for containing the ball 171 therein. That is, the corresponding two ends of the ball 171 are against to the first groove 172 and the second groove 173, respectively. Therefore, the ball 171 can align the driving base 160 and the driving head 130 stably.

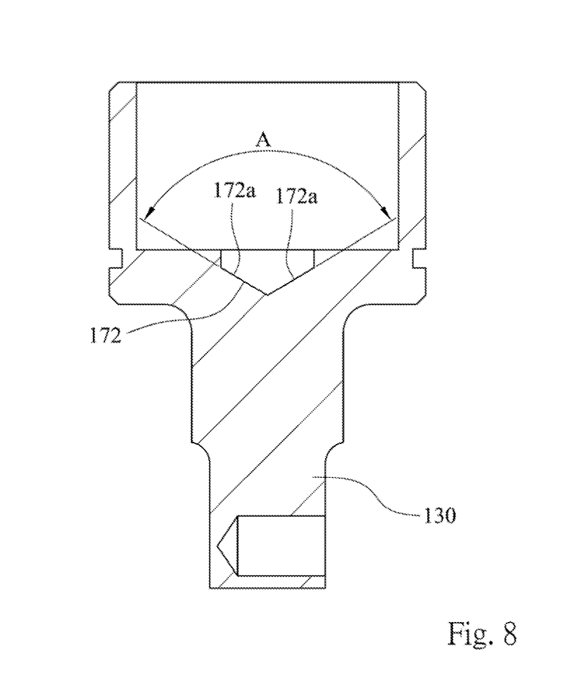

FIG. 8 is a cross-sectional view of the driving head 130 of the torque screwdriver 100 according to the embodiment of FIG. 7. In FIG. 8, the first groove 172 includes two bottom surfaces 172a, wherein an angle A between the bottom surfaces 172a is equal to or greater than 45 degrees and equal to or less than 140 degrees. The ball 171 can be contained in the first groove 172 and against to the bottom surfaces 172a. It is favorable for stably aligning the driving base 160 and the driving head 130, and increasing the aligning precision. Moreover, the second groove 173 can also include two bottom surfaces, and the angle between the bottom surfaces can be equal to the angle A of the first groove 172, and will not be described again herein.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A torque screwdriver, comprising:
a handle;
a tube body, one end of the tube body connected to the handle;
a torque adjusting mechanism disposed in the tube body and for providing a predetermined torque value;
a tripping mechanism disposed in the tube body, one end of the tripping mechanism pushed by the torque adjusting mechanism;
a driving base disposed in the tube body and located in the other end of the tube body, one end of the driving base pushed by the other end of the tripping mechanism; and
a driving head connected to the other end of the tube body, one end of the driving head embedded between the driving base and an inner wall of the tube body, and the driving head driven by the driving base, wherein the driving head comprises:
an embedding structure located on an outer wall of the end of he driving head, and against to the inner wall of the tube body; and
a stepped structure located on the outer wall of the end of the driving head for forming a gap between the inner wall of the tube body and thereof.

2. The torque screwdriver of claim 1, wherein the driving base is an unidirectional ratchet for driving the driving head to rotate in a predetermined direction.

3. The torque screwdriver of claim 1, wherein the tube body comprises:
an upper tube body connected to the handle, and the torque adjusting mechanism disposed therein; and
a lower tube body connected to the upper tube body, and the tripping mechanism disposed therein.

4. The torque screwdriver of claim 3, wherein the lower tube body is welded to the upper tube body.

5. The torque screwdriver of claim 3, wherein the lower tube body is integrated with the upper tube body.

6. The torque screwdriver of claim 3, wherein the tube body further comprises:
a sleeving member connecting the lower tube body and the driving head.

7. The torque screwdriver of claim 6, further comprising:
a bearing disposed between the sleeving member and the driving head.

8. The torque screwdriver of claim 3, wherein a diameter of the lower tube body is greater than a diameter of the upper tube body.

9. The torque screwdriver of claim 3, wherein an axial length of the upper tube body is greater than an axial length of the lower tube body.

10. The torque screwdriver of claim 1, further comprising:
a gasket disposed between the handle and the tube body.

11. The torque screwdriver of claim 1, wherein an axial length of the stepped structure is greater than an axial length of the embedding structure.

12. The torque screwdriver of claim 1, wherein the stepped structure is a groove.

13. A torque screwdriver, comprising:
a handle;
a tube body, one end of the tube body connected to the handle;
torque adjusting mechanism disposed in the tube body and for providing a predetermined torque value;
a tripping mechanism disposed in the tube body, one end of the tripping mechanism pushed by the torque adjusting mechanism;
a driving base disposed in the tube body and located in the other end of the tube body, one end of the driving base pushed by the other end of the tripping mechanism;
a driving head connected to the other end of the tube body, one end of the driving head embedded between the driving base and an inner wall of the tube body, and the driving head driven by the driving base, wherein a gap is formed between the driving head and the tube body; and
a self-calibrated mechanism located between the driving head and the driving base for aligning an axis of the driving base with an axis of the driving head.

14. The torque screwdriver of claim 13, wherein the self-calibrated mechanism comprises:
a ball against to the driving head and the driving base.

15. The torque screwdriver of claim 14, wherein the self-calibrated mechanism further comprises:
a first groove formed on one end of the driving head for containing the ball therein.

16. The torque screwdriver of claim 15, wherein the first groove comprises:
two bottom surfaces, wherein an angle between the bottom surfaces is equal to or greater than 45 degrees and equal to or less than 140 degrees.

17. The torque screwdriver of claim 14, wherein the self-calibrated mechanism further comprises:
a second groove formed on one end of the driving base for containing the ball therein.

18. The torque screwdriver of claim 13, wherein the driving base is an unidirectional ratchet for driving the driving head to rotate in a predetermined direction.

19. The torque screwdriver of claim 13, wherein the driving base is an unidirectional ratchet, a tooth element of the unidirectional ratchet element is unidirectionally meshed to a tooth portion on an inner wall of the driving head.

20. The torque screwdriver of claim 13, wherein the driving head comprises:
an embedding structure located on an outer wall of the end of the driving head, and against to the inner wall of the tube body; and
a stepped structure located on the outer wall of the end of the driving head for forming the gap between the inner wall of the tube body and thereof.

21. The torque screwdriver of claim 13, wherein the tube body comprises:
an upper tube body connected to the handle, and the torque adjusting mechanism disposed therein; and
a lower tube body connected to the upper tube body, and the tripping mechanism disposed therein.

22. The torque screwdriver of claim 21, wherein the lower tube body is welded to the upper tube body.

23. The torque screwdriver of claim 21, wherein the lower tube body is integrated with the upper tube body.

24. The torque screwdriver of claim 2 , wherein the tube body further comprises:
a sleeving member connecting the lower tube body and the driving head.

25. The torque screwdriver of claim 24, further comprising:
a bearing disposed between the sleeving member and the driving head.

26. The torque screwdriver of claim 21, wherein a diameter of the lower tube body is greater than a diameter of the upper tube body.

27. A torque screwdriver, comprising:
a handle;
a tube body comprising:
an upper tube body connected to the handle; and
a lower tube body connected to the upper tube body, wherein a diameter of the lower tube body is greater than a diameter of the upper tube body;
a torque adjusting mechanism disposed in the upper tube body and for providing a predetermined torque value;
a tripping mechanism disposed in the lower tube body, and comprising:
first ball member against to the torque adjusting mechanism; and
at least two second ball members slidably pushed by the first ball member, and against to an inner wall of the lower tube body;
a driving base disposed in the lower tube body, the first ball member and the second ball members are contained in one end of the driving base; and
a driving head connected to the other end of the tube body, one end of the driving head embedded between the driving base and the inner wall of the lower tube body, and the driving head driven by the driving base, wherein a gap is formed between the driving head and the tube body.

28. The torque screwdriver of claim 27, wherein the driving base comprises:
a containing groove, the first ball member and the second ball members located in the containing groove; and
at least two through holes formed on a side wall of the containing groove, wherein the second bail members are against to the inner wall of the lower tube body through the through holes.

29. The torque screwdriver of claim 28, wherein when each of the second ball members is driven in a driving position, a radial distance perpendicular to an axial line of the tube body between the axial line of the tube body and the a center of each of the second ball members is L1, when each of the second ball members is driven in a tripping position, a radial distance perpendicular to the axial line of the tube body between the axial line of the tube body and the a center of each of the second ball members is L2, and L1 is greater than L2.

30. The torque screwdriver of claim 28, wherein the lower tube body comprises at least four positioning areas and at least four tripping areas alternately located on the inner wall thereof.

31. The torque screwdriver of claim 27, further comprising:
a gasket disposed between the handle and the tube body.

32. The torque screwdriver of claim 27, wherein a diameter of the lower tube body is greater than a diameter of the upper tube body.

33. The torque screwdriver of claim 27, wherein the tube body further comprises:
a sleeving member connecting the lower tube body and the driving head.

34. The torque screwdriver of claim 27, further comprising:
a bearing disposed between the sleeving member and the driving head.

35. The torque screwdriver of claim 27, wherein an axial length of the upper tube body is greater than an axial length of the lower tube body.
